(19) United States
(12) Patent Application Publication
(10) Pub. No.: US 2006/0224758 A1
(43) Pub. Date: Oct. 5, 2006

(54) System and method for file header operation in a peer-to-peer network providing streaming services

(75) Inventors: Xiangyang Chen, Beijing (CN); Xin Yu, Beijing (CN)

Correspondence Address: HAYNES AND BOONE, LLP, 901 MAIN STREET, SUITE 3100, DALLAS, TX, 75202, US

(73) Assignee: 1000 Oaks Hu Lian Technology Development Co., Ltd., Beijing (CN)

(21) Appl. No.: 11/175,861

(22) Filed: Jul. 6, 2005

Related U.S. Application Data
(60) Provisional application No. 60/662,131, filed on Mar. 15, 2005.

(51) Int. Cl. G06F 15/16

(52) U.S. Cl. 709/231

(57) ABSTRACT

A method, computer-readable medium and data processing system for streaming content operation in a peer-to-peer network. A peer client in the peer-to-peer network connects with a node of the peer-to-peer network. The client receives header data associated with the streaming content and stores the header data in a local storage of the client.

### RELATED APPLICATION DATA

This patent application claims the benefit of provisional U.S. Patent Application Ser. No. 60/662,131, filed Mar. 15, 2005.

### BACKGROUND

In a client-server network adapted to provide streaming multimedia services such as streaming video or audio, many clients may participate in a video streaming session. The processing capacity of a media server in such a network is limited. If the number of clients connected to the media server exceeds the processing or transmission capacity of the server, the media server may be unable to provide a high quality of service to the clients, crash, discontinue service to clients, or refuse service or connection to clients.

Service problems associated with excessive loads placed on a streaming source in a client-server network have conventionally been addressed by deploying multiple servers in the client-server network. For example, multiple servers may be deployed in a cluster mode such that connecting clients are unaware of the multiple servers providing the streaming content. However, cluster mode server configurations can only provide improved streaming service quality from a processing performance standpoint. Problematically, streaming service deficiencies related to transmission capacity are not addressed by cluster mode solutions in a client-server network.

Conventional playback of a streaming transmission requires retrieval of a file header associated with the streaming content for proper playback of streaming content that is partitioned and transmitted in one or more data blocks. The file header is provided to a client on request of the streaming content by the client. The client uses information in the header for proper processing of streaming content conveyed thereto in the data blocks. In conventional streaming session implementations, a client will discard the file header upon playback of the streaming content received in the data block stream.

### BRIEF DESCRIPTION OF THE DRAWINGS

Aspects of the present disclosure are best understood from the following detailed description when read with the accompanying figures, in which:

FIG. 1 is a diagrammatic representation of an embodiment of a peer-to-peer network that facilitates streaming content operation;

FIG. 2 is a diagrammatic representation of an embodiment of a streaming content file having content that may be distributed in a peer-to-peer network;

FIG. 3 is a diagrammatic representation of an embodiment of segmented streaming content formatted for transmission in a peer-to-peer network;

FIG. 4 is a diagrammatic representation of an embodiment of a software configuration that facilitates distribution of streaming content header data in a peer-to-peer network;

FIG. 5 is a flowchart of an embodiment of a processing routine performed by a streaming source for distribution of streaming content and header data in a peer-to-peer network; and

FIG. 6 is a flowchart of an embodiment of a processing routine performed by a peer client for retrieval and distribution of streaming content and header data in a peer-to-peer network.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

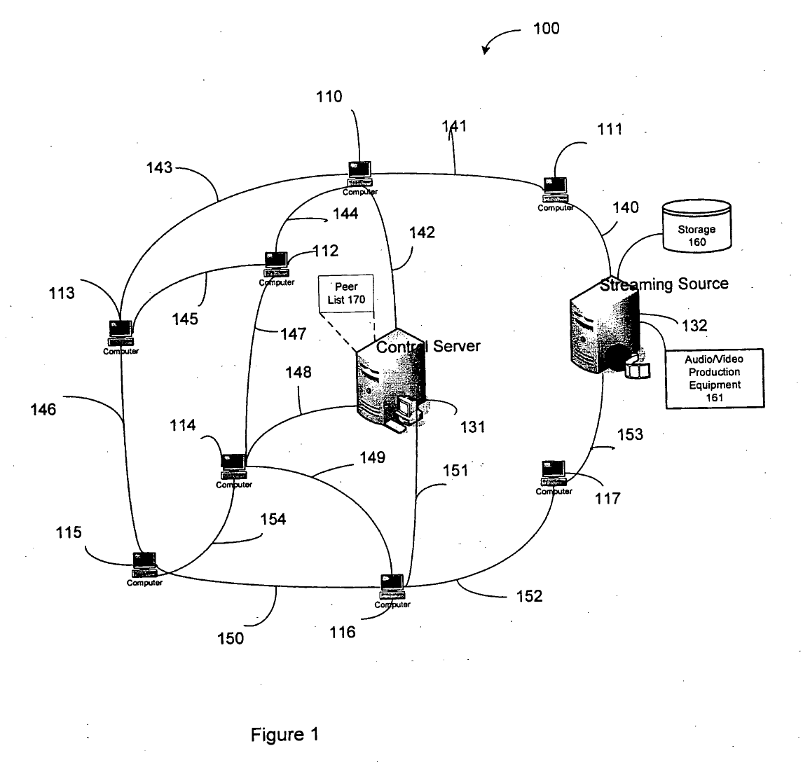

FIG. 1 is a diagrammatic representation of an embodiment of a peer-to-peer network 100 that facilitates streaming content operation. Network 100 includes various peer clients 110-117 that may be interconnected with other clients in network 100. Additionally, network 100 may include a control server 131 and a streaming source 132. One or more clients may connect with control server 131 and streaming source 132 in addition to other network clients. Clients 110-117 may connect with other network clients, control server 131 and streaming source 132 by network connections 140-154, such as wire, wireless communication links, fiber optic cables, or other suitable network media.

Control server 131 may facilitate connection of new clients within network 100 and organize clients 110-117 that have joined network 100. Clients 110-117 may be implemented as data processing systems, such as personal computers, wired or wireless laptop computers, personal digital assistants, or other computational devices capable of network communications.

Streaming source 132 may be implemented as a server that stores or accesses streaming content, such as video, audio, or the like, and streams the data to one or more clients in network 100. For example, the streaming content may be retrieved from a file that is accessed by streaming source 132 from a storage device 160. Alternatively, the streaming content may be produced from, for example, audio/video production equipment 161 that is interfaced with streaming source 132. The streaming content may comprise data encoded in a native streaming format, such as RealAudio formatted files, RealVideo formatted files, ASF, or another streaming format that may be processed by a streaming media application, such as RealPlayer, Windows Media Player, or another streaming media application. The native formatted streaming content may be encapsulated in a network transport format that facilitates transmission of data among peer clients of network 100. Streaming source 132 may segment streaming content into data blocks that are distributed within network 100 as described more fully below. Various clients 110-117 may receive and store different data blocks of the streaming content.

Control server 131 maintains a peer list 170 that includes connectivity information, such as a network address and port number, of respective peer clients that are connected within peer-to-peer network 100. When control server 131 generates peer list 170, connectivity information of streaming source 132 may be the only connectivity information included in peer list 170. A client joins peer-to-peer network 100 by first connecting with control server 131 and submitting a request for peer list 170. The control server returns peer list 170 to the requesting client, and the client joins network 100 by selecting one or more nodes having connectivity information included in peer list 170 and connecting with the selected nodes.

When a new client joins peer-to-peer network 100, control server 132 may add connectivity information of the newly joining client to peer list 170. In this manner, as additional clients join peer-to-peer network 100, the availability of peer clients with which subsequently joining clients may connect is increased. Connectivity information of streaming source 132 may be removed from peer list 170, for example when the number of clients connected within peer-to-peer network 100 reaches a pre-defined threshold. In this manner, the streaming session load placed on streaming source 132 may be reduced. A client connected within peer-to-peer network 100 that desires streaming content originally provided by streaming source 132 may submit a query for the streaming content to peer clients with which the requesting client is connected. If no peer clients within network 100 have the requested streaming content (or no peer clients within network 100 are available for delivery of the streaming content to the requesting client), the requesting client may obtain the streaming content from streaming source 32.

A peer client that receives streaming content from streaming source 132 may be configured to cache or temporarily store the streaming content (or a portion thereof) for playback. Additionally, a client may distribute cached streaming content to other peer clients. Streaming content may be segmented by streaming source 132 into data blocks that each have an associated sequence number. Playback of streaming content is performed by arranging data blocks into a proper sequence based on the data blocks' sequence numbers. In accordance with embodiments described herein, a peer client may cache streaming content header data for distribution to other peer clients thereby further decreasing the load placed on a streaming source.

Network 100 may comprise a transient Internet network, and thus clients 110-117, control server 131, and streaming source 132 may use the Transmission Control Protocol/Internet Protocol (TCP/IP) suite of protocols to communicate with one another. Alternatively, network 100 may be implemented in any number of different types of networks, such as for example, an intranet, a local area network (LAN), or a wide area network (WAN). Additionally, control server 131 and streaming source 132 are shown as distinct entities within network 100. However, control server 131 and streaming source 132 may be collectively implemented in one or more common network nodes. FIG. 1 is intended as an example, and not as an architectural limitation of embodiments described herein.

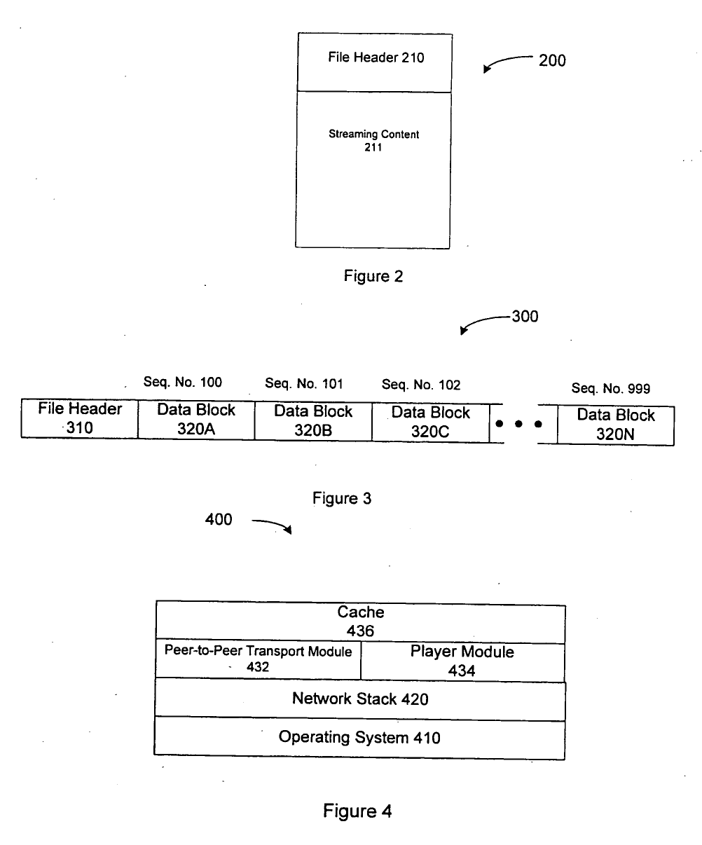

FIG. 2 is a diagrammatic representation of an embodiment of a streaming content file 200 having content that may be distributed in peer-to-peer network 100. Streaming content file 200 may include a file header 210 and streaming content 211. File header 210 may include various control or information fields that facilitate processing of streaming content 211 for proper playback thereof. For example, file header 210 may include fields that have values specifying the encoder used for encoding streaming content 211, protocol version of the streaming content data, the length of data included in streaming content file 200, or other data that may be used for playback of the streaming content. Streaming content 211 may include encoded video, audio, or other multimedia data.

Streaming content file 200 may be provided to clients from streaming source 132 (FIG. 1). For example, streaming source 132 may fetch streaming content file 200 from storage device 160 connected or otherwise interfaced with streaming source 132, or streaming content file 200 may be generated by streaming source 132 and adjunct equipment, for example from audio/video production equipment 161. In this configuration, streaming source 132, or equipment connected therewith, generates file header 210 having parameters or field values that facilitate processing of streaming content 211.

Streaming content, whether retrieved from a file or produced by audio/video production equipment or another source, may be segmented into data blocks for transmission in peer-to-peer network 100. Streaming content data blocks may be associated with a respective sequence number to facilitate caching of streaming content within peer-to-peer network and to facilitate playback of streaming content. In accordance with embodiments described herein, content of file header 210 may be cached or otherwise stored by peer clients for distribution to other peers within peer-to-peer network 100.

FIG. 3 is a diagrammatic representation of an embodiment of segmented streaming content 300 formatted for transmission in a peer-to-peer network. Segmented streaming content 300 may be generated by streaming source 132 by segmenting or otherwise dividing streaming content file 200 into segments or data blocks. For example, the streaming source may extract file header 210 from streaming content file 200 and store the extracted information as a file header block 310 in a cache or other storage device. Additionally, streaming source 132 may partition or otherwise segment streaming content 211 into groups of one or more data blocks 320A-320N. Streaming source 132 may store data blocks 320A-320N in a local storage device, and one or more of data blocks 320A-320N may then be transmitted to peers connected with streaming source 132. Preferably, streaming source 132 associates a respective sequence number with each data block of the streaming content. For example, streaming source 132 may insert, append, or otherwise associate one of a series of sequence numbers to each data block 320A-320N of segmented streaming content 300. In the illustrative example, each of data blocks 320A-320N have a respective sequence number 100-999 associated therewith.

A client in network 100 first receives file header block 310 prior to being able to playback any streaming content received in data blocks 320A-320N. One or more of data blocks 320A-320N may be received by the client, cached thereby, and assembled into sequential order based on data block sequence numbers for playback of the streaming content. Additionally, a client may cache one or more received data blocks 320A-320N for later transmission to other peer clients requesting the streaming content. Moreover, one or more clients may cache header block 310 for distribution in peer-to-peer network 100.

In accordance with embodiments described herein, a peer client may store header block 310 upon receipt thereof during a streaming session performed in peer-to-peer network 100 in addition to extracting various parameters from header block 310 for playback of streaming content contained in data blocks 320A-320N. For example, assume a peer client obtains segmented streaming content 300 from streaming source 132. The client, upon receipt of header block 310, parses or otherwise extracts parameters therefrom to facilitate proper playback of streaming content contained in data blocks 320A-320N. Additionally, the client may store header block 310 in a storage device thereof, such as a file cache, and may store one or more of data blocks 320A-320N. The client may then distribute header block 310 and may distribute one or more of stored data blocks 320A-320N to other peer clients upon receipt of a request for streaming content contained in segmented streaming content 300. Thus, the processing and transmission capacity of streaming source 132 for distribution of header information for playback of streaming content is reduced.

To facilitate proper playback of streaming content, the streaming source may compute or otherwise derive an error detection and correction code, such as a checksum code, a cyclic redundancy code, or the like, from the header block 310. The error detection and correction code may then be conveyed to any peer client that obtains header block 310 from the streaming source. For example, the error detection and correction code may be inserted into a field of header block 310, appended to header block 310, or provided to a client in some other manner, such as transmitting the error detection and correction code in one or more packets with an identification or association of header block 310. A client receiving header block 310 and a corresponding error detection and correction code may then verify the veracity of header block 310 prior to processing one or more of data blocks 320A-320N for playback of streaming content. The client may store the error detection and correction code with header block 310 for distribution to other peer clients within peer-to-peer network 100. Alternatively, the client may generate an error detection and correction code from its locally cached header block prior to distribution of the header block to other peer clients. For example, a client having header block 310 stored in its local cache may receive a request for streaming content contained in one or more of data blocks 320A-320N. Additionally, the client may receive a request for header block 310 that accompanies the request for the streaming content. In this instance, the client that has received the request may calculate or otherwise generate an error detection and correction code from its locally stored copy of header block 310 and transmit the header block, along with the calculated error correction and detection code, to the requesting client.

FIG. 4 is a diagrammatic representation of an embodiment of a software configuration 400 that facilitates distribution of streaming content header data in a peer-to-peer network. Software configuration 400 comprises sets of computer-executable instructions or code that may be fetched from a memory and executed by a processing unit of a data processing system. Software configuration 400 is preferably run by a peer-to-peer client, such as one or more of clients 110-117 shown in FIG. 1.

Software configuration 400 may include an operating system 410, such as a Windows operating system manufactured by Microsoft Corporation of Redmond, Wash., an OS/2 operating system manufactured by International Business Machines Corporation of Armonk, N.Y., or the like. Operating system 410 may include a network stack 420 for effecting network communications. For example, network stack 420 may be implemented as a transmission control protocol/Internet protocol (TCP/IP) stack.

Software configuration 400 may include a peer-to-peer transport module 432 that comprises logic for self-administration of the peer-to-peer network structure. For example, peer-to-peer transport module 432 may provide self-adjusting functions of the peer client location in the peer-to-peer network topology. Additionally, transport module 432 may provide network transmission and reception functions for data streams. For example, transport module 432 may supply one or more data blocks, such as data blocks 320A-320N, formatted for delivery in network 100 to network stack 420 for transmission in the peer-to-peer network. Transport module 432 may maintain socket data of peer connections, retrieval functions of data cached by the client for transmission to another client, or other functions that facilitate the client downloading or uploading media data from and to other peer clients or network nodes.

A player module 434, such as a media player application, may be included in software configuration 400 and comprises logic for playback or other processing of streaming data. Transport module 432 may be included with, or interface with, player module 434. Player module 434 may perform error detection on header data and may parse or otherwise extract parameters from streaming content header data that facilitates proper playback of the streaming content. Additionally, player module 434 may store header data, for example in cache 436, for later distribution to other peer clients. Player module 434 may also store streaming content data blocks to cache 436 for later distribution to peer clients. In accordance with embodiments described herein, transport module 432 may include logic that facilitates the distribution of streaming content header data in peer-to-peer network. For example, transport module 432 may interface with cache 436 and retrieve header data therefrom. Transport module 432 may then distribute header data retrieved from cache 436 to other peer clients within peer-to-peer network 100.

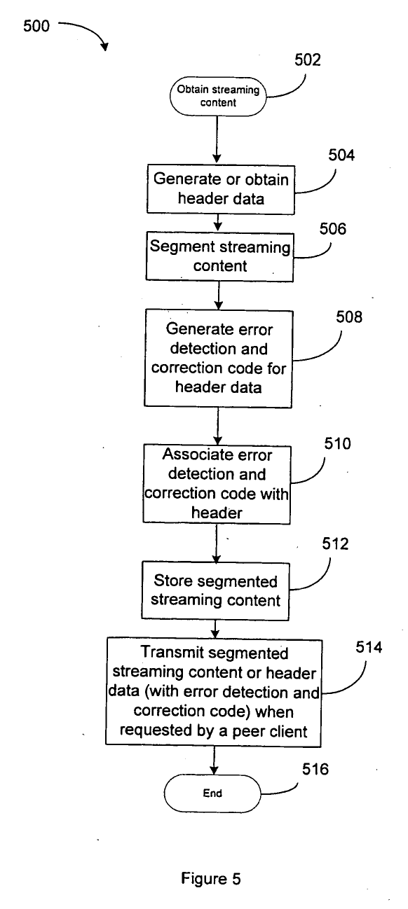

FIG. 5 is a flowchart 500 of an embodiment of a processing routine performed by streaming source 132 for distribution of streaming content and header data in a peer-to-peer network. Streaming source 132 obtains streaming content (step 502), for example from a file or from streaming content production equipment. The streaming source then generates or obtains header data associated with the streaming content (step 504). For example, the header data may be parsed from the obtained streaming content or may be calculated based on the streaming content and written to a header data block. The streaming content may then be segmented into one or more data blocks (step 506). An error detection and correction code may then be generated for the header data (step 508), and streaming source 132 may associate the error detection and correction code with the header data (step 510). For example, the error detection and correction code may be appended or inserted into the header data. Alternatively, the error detection and correction code may be logically associated with the header data. The segmented streaming content and header data, as well as the error detection and correction code, may then be stored by the streaming source for delivery to peer clients (step 512). The segmented streaming content (or a portion thereof) and header data as well as the error detection code may then be transmitted to a peer client when a request for the streaming content is received by the streaming source from the peer client (step 514). The streaming source processing cycle may then end (step 516).

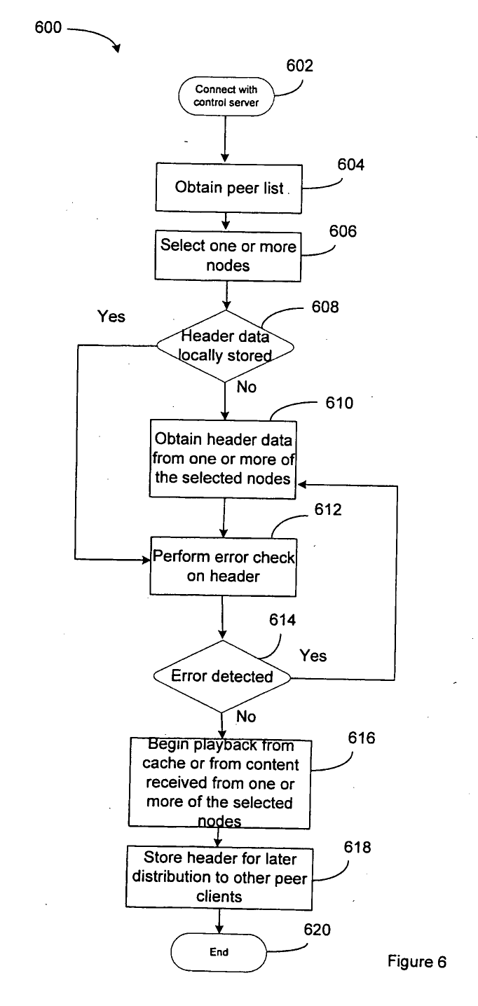

FIG. 6 is a flowchart 600 of an embodiment of a processing routine performed by a peer client for retrieval and distribution of streaming content and header data in a peer-to-peer network. A client may first connect with a control server (step 602), for example to submit a request for a peer list thereto. The client then obtains a peer list from the control server that specifies connectivity information of other peer clients with which the client may connect for distribution of data within the peer-to-peer network (step 604). The client then selects one or more nodes in the peer list (step 606) and may connect with the selected peer nodes. An evaluation may then be made to determine if header data is locally stored by the client (step 608). If the header data is locally stored by the client, the client may then perform an error detection calculation on the locally stored header data (step 612).

If it is determined that header data is not locally stored by the client at step 608, the client may obtain the header data from one or more of the selected nodes (step 610) and perform an error check on the obtained header data according to step 612. Once an error detection calculation has been made by the client, an evaluation may be made to determine if an error in the header data was detected by the client (step 614). In the event that an error was detected by the client in the header data, the client may connect with one or more of the nodes identified in the peer list to obtain another copy of the header data according to step 610.

Once an error free header data is obtained by the client, the client may begin playback of streaming content that is stored locally in the client's cache or from streaming content that is obtained from one or more of the nodes selected from the peer list (step 616). The client may then store the header data in its local cache for later distribution to other peer clients (step 618), and the client processing cycle may then end (step 620).

Embodiments described herein provide mechanisms for streaming content operation in a peer-to-peer network. A client may connect with a node of the peer-to-peer network, and receive header data associated with streaming content. The header data may be used by the client for processing of streaming content stored in the client's cache or received by the client from one or more peer nodes. The client may store the header data in a local storage and later distribute the header data to other peer clients that request the associated streaming content. Thus, the load placed on a streaming source for distribution of streaming content header information may be advantageously reduced.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims.

What is claimed is:

1. A method of streaming content operation in a peer-to-peer network, comprising:
connecting, by a peer client in the peer-to-peer network, with a node of the peer-to-peer network;
receiving, by the client, header data associated with streaming content; and
storing, by the client, the header data in a local storage of the client.

2. The method of claim 1, further comprising:
submitting, by the client, a request for the streaming content in the peer-to-peer network;
receiving, by the client, one or more data blocks each respectively containing a portion of the streaming content; and
processing the one or more data blocks according to the header data.

3. The method of claim 2, further comprising connecting with a plurality of clients of the peer-to-peer network, wherein each of the one or more data blocks are respectively received from one of the plurality of clients.

4. The method of claim 1, wherein connecting with the node further comprises connecting with a multimedia streaming source.

5. The method of claim 1, further comprising:
receiving, by the client, a request for the header data from a second peer client of the peer-to-peer network;
retrieving, by the client, the header data from the local storage; and
transmitting, by the client, the header data to the second client through the peer-to-peer network.

6. The method of claim 1, further comprising:
performing, by the client, an error check of the header data;
identifying, by the client, an error within the header data; and
submitting a request for the header data to one or more nodes of the peer-to-peer network.

7. The method of claim 1, wherein the node is a streaming source, the method further comprising extracting, by the streaming source, the header data from a streaming content file.

8. The method of claim 1, further comprising producing, by audio or video production equipment, the header data.

9. A computer-readable medium having computer-executable instructions for execution by a processing system, the computer-executable instructions for facilitating streaming content operation in a peer-to-peer network, comprising:
instructions that connect a peer client in the peer-to-peer network with a node of the peer-to-peer network;
instructions that receive header data associated with streaming content; and
instructions that store the header data in a local storage of the client.

10. The computer-readable medium of claim 9, further comprising:
instructions that submit a request for the streaming content in the peer-to-peer network;
instructions that receive one or more data blocks each respectively containing a portion of the streaming content; and
instructions that process the one or more data blocks according to the header data.

11. The computer-readable medium of claim 10, further comprising instructions that connect the peer client with a plurality of clients of the peer-to-peer network, wherein each of the one or more data blocks are respectively received by the peer client from one of the plurality of clients.

12. The computer-readable medium of claim 9, wherein the instructions that connect with the node further comprise instructions that connect with a multimedia streaming source.

13. The computer-readable medium of claim 9, further comprising:
instructions that receive a request for the header data from a second peer client of the peer-to-peer network;
instructions that retrieve the header data from the local storage; and
instructions that transmit the header data to the second client through the peer-to-peer network.

14. The computer-readable medium of claim 9, further comprising:
instructions that perform an error check of the header data;
instructions that identify an error within the header data; and
instructions that submit a request for the header data to one or more nodes of the peer-to-peer network.

15. The computer-readable medium of claim 9, wherein the node is a streaming source, the computer-readable medium further comprising instructions executed by the streaming source that extract the header data from a streaming content file.

16. The computer-readable medium of claim 9, further comprising instructions that produce the file header data that are executed by audio or video production equipment.

17. A data processing system for distributing and processing streaming content in a peer-to-peer network, comprising:
a memory that contains a set of instructions;
a network adapter that interfaces with a communications medium; and
a processing unit that, responsive to execution of the sets of instructions, connects the data processing system with a node of the peer-to-peer network, receives header data associated with streaming content, and stores the header data in a local storage of the client.

18. The data processing system of claim 17, wherein the processing unit submits a request for the streaming content, receives one or more data blocks each respectively containing a portion of the streaming content, and processes the one or more data blocks according to the header data.

19. The data processing system of claim 17, wherein the processing unit connects with a control server in the peer-to-peer network and obtains a peer list that includes connectivity information of the node.

20. The data processing system of claim 17, wherein the processing unit receives a request for the header data from a client in the peer-to-peer network, retrieves the header data from the local storage, and transmits the header data to the client on the communications medium.

21. A method of streaming content operation in a peer-to-peer network, comprising:
connecting, by a peer client in the peer-to-peer network, with a node of the peer-to-peer network;
receiving, by the client, header data associated with streaming content;
processing, by the client, the streaming content according to the header data; and
storing, by the client, the header data in a local storage of the client.

22. The method of claim 21, further comprising:
receiving, by the client, a request for the header data from a second peer client of the peer-to-peer network;
retrieving, by the client, the header data from the local storage; and
transmitting, by the client, the header data to the second client through the peer-to-peer network.

23. The method of claim 21, wherein the streaming content comprises a plurality of streaming content segments received from a respective node of a plurality of nodes in the peer-to-peer network.
